(19) United States
(12) Patent Application Publication
(10) Pub. No.: US 2013/0108988 A1
(43) Pub. Date: May 2, 2013

(54) SYSTEMS AND METHODS FOR FABRICATING DENTAL PROSTHESES IN A SINGLE OFFICE VISIT

(71) Applicant: Stefan J. Simoncic, Cary, NC (US)

(72) Inventor: Stefan J. Simoncic, Cary, NC (US)

(21) Appl. No.: 13/282,091

(22) Filed: Oct. 26, 2011

(51) Int. Cl. A61C 13/34; A61C 9/00; G06F 17/50; A61C 13/10

(52) U.S. Cl. 433/192; 433/213; 700/98

(57) ABSTRACT

A method for fabricating a dental prosthesis during a single office visit includes: scanning a template that is representative of at least a portion of a patient's intra-oral anatomy to create a computer aided design (CAD) model of the template; manipulating the CAD model of the template to design a base for the dental prosthesis having a plurality of recesses shaped to receive teeth; fabricating the base from the manipulated CAD model; and securing prosthetic teeth in the recesses of the fabricated base.

### FIELD OF THE INVENTION

This invention relates to dental prostheses and, more particularly, to systems and methods for fabricating dental prostheses.

### BACKGROUND

The conventional process for producing a dental prosthesis such as a denture includes multiple clinical consultations between a patient and a practitioner, with each clinical consultation followed by work performed by a technician.

Following an initial assessment of the patient by the practitioner, the process commences by taking primary impressions of the patient's upper and lower mouth using stock trays. The primary impressions are sent to the technician who casts impressions in stone from which custom trays are produced for the patient. The custom trays are sent to the practitioner who takes secondary impressions using the custom trays. The secondary impressions are sent back to the technician who casts secondary impressions in stone and produces wax registration rims from the stone secondary impressions. The wax registration rims are then sent to the practitioner.

The practitioner performs the registration of the patient's jaw relations and the wax registration rims are marked up and returned to the technician. The technician places the wax registration rims on an articulator and follows the markings and dimensions placed on the rims. Artificial teeth selected for the patient are mounted one-by-one by the technician according to the prescribed dimensions on the wax registration rims. The teeth are precisely set and the wax is meticulously sculpted and cleaned before the teeth/wax base apparatus is returned to the practitioner for “try-in” by the patient. It is well known in the art that this is a very time consuming process and one that is prone to error. After the wax “try-in,” the teeth/wax base apparatus is returned to the technician. It is noted that the handling and back-and-forth transport of the apparatus can cause the teeth to shift due to the relatively soft wax base.

The technician begins processing the denture by investing the teeth and wax base in a flask and heating the flask in a water bath to remove the wax base. The remaining space is filled with a heat or autopolymerizing denture base material. It is noted that the denture teeth may move during this procedure, further increasing the chance for error. The processed denture is then sent back to the practitioner.

The patient tries the denture and checks are made to ensure that the fit and the bite is correct. Checks are also made for pain spots or unwanted discrepancies, such as premature contact, fulcrum tilting or any displeasing aesthetic factors. If such problems exist and cannot be corrected in the practitioner's office, the denture must be returned at least once to the technician to make adjustments until both the practitioner and patient are happy with the fit and appearance of the denture.

Even when the above-described process runs smoothly, it is time-consuming (in particular, setting the teeth in wax and sculpting the wax can take hours). Moreover, the practitioner's office and the technician's laboratory are typically remotely located such that the back-and-forth transport of objects such as the impressions, “try-in” apparatus and finished dentures increases the time the patient must wait for a finished product. Also, the repeated shipping and handling increases cost and may damage the objects.

However, the above-described process often does not run smoothly. When the “finished” dentures are ill-fitting, the practitioner must attempt to correct the dentures while the patient is in the chair. When this is not possible, the dentures must be returned to the laboratory for rework. In the worst-case scenario, the faulty denture is discarded and the aforementioned laborious process is to a large extent repeated to create a new denture.

There is a need for high-quality dental prostheses, such as dentures, that can be fabricated in a single office visit by eliminating or streamlining at least some of the steps described above and by giving the practitioner more control over the entire fabrication process from start to finish.

### SUMMARY OF EMBODIMENTS OF THE INVENTION

Some embodiments of the invention are directed to a method for fabricating a dental prosthesis during a single office visit. The method includes: scanning a template that is representative of at least a portion of a patient's intra-oral anatomy to create a computer aided design (CAD) model of the template; manipulating the CAD model of the template to design a base for the dental prosthesis having a plurality of recesses shaped to receive teeth; fabricating the base from the manipulated CAD model; and securing prosthetic teeth in the recesses of the fabricated base.

The template may comprise radio-opaque material. Scanning the template may be performed using a cone beam computerized tomography (CBCT) scanner.

The template may comprise a baseplate formed on a cast of an impression of at least a portion of the patient's intra-oral anatomy and an occlusion rim attached to the baseplate. The template may be formed by: taking an impression of at least a portion of the patient's intra-oral anatomy; forming a cast of the impression; applying a wax baseplate over the cast; attaching a wax occlusion rim to the wax baseplate; and/or performing occlusal registration with the baseplate and occlusion rim in the patient's mouth.

Manipulating the CAD model of the template may include one or more of the following: using a CAD model of prosthetic teeth to design a location and shape of each of the plurality of recesses; and adding surface festoons to the CAD model that are representative of intra-oral anatomical features.

Securing prosthetic teeth in the recesses may include adhesively securing the prosthetic teeth in the recesses. The prosthetic teeth may be interconnected to facilitate placement within the recesses. The prosthetic teeth may be interconnected by a removable or non-removable member that may be flexible. Each of at least some of the prosthetic teeth may include a downwardly extending projection configured to be received in a cavity formed in a respective recess of the fabricated base.

Fabricating the base may comprise milling the dental prosthesis base from polymeric material. The prosthetic teeth may comprise polymeric material.

Other embodiments of the invention are directed to a method for fabricating a dental prosthesis during a single office visit, comprising: scanning intra-oral anatomy of a patient using a cone beam computerized tomography (CBCT) scanner; displaying a computer aided design (CAD) model representing the scanned intra-oral anatomy; manipulating the CAD model to design a base for the dental prosthesis having a plurality of recesses shaped to receive teeth; fabricating the base from the manipulated CAD model; and securing prosthetic teeth in the recesses of the fabricated base.

Other embodiments of the invention are directed to a system for fabricating a dental prosthesis during a single office visit. The system includes: a scanning device configured to acquire three dimensional data of a patient's intra-oral anatomy; a design station in communication with the scanning device, wherein the design station is configured to display a computer aided design (CAD) model of the patient's intra-oral anatomy based on three dimensional data acquired by the scanning device, and wherein the design station is configured to manipulate the CAD model to design a base for the dental prosthesis having a plurality of recesses shaped to receive teeth; and a fabrication unit in communication with the design station, wherein the fabrication unit is configured to fabricate the dental prosthesis base from the manipulated CAD model.

The fabrication unit may be further configured to: secure a plurality of prosthetic teeth in the recesses of the fabricated dental prosthesis base; adhesively secure the plurality of prosthetic teeth in the recesses of the dental prosthesis base; and/or add surface festoons to the dental prosthesis base that are representative of intra-oral anatomical features. The fabrication unit may be a milling unit configured to mill the dental prosthesis base from polymeric material.

Other embodiments of the invention are directed to a computer program product for fabricating a dental prosthesis during a single office visit, comprising a non-transitory computer readable storage medium having encoded thereon instructions that, when executed on a computer, cause the computer to: scan a template that is representative of at least a portion of a patient's intra-oral anatomy to create a computer aided design (CAD) model of the template; and manipulate the CAD model of the template to design a base for the dental prosthesis having a plurality of recesses shaped to receive teeth.

In some embodiments, the computer readable storage medium has encoded thereon instructions that, when executed on a computer, causes the computer to fabricate the base from the manipulated CAD model via a fabrication apparatus. In some embodiments, the computer readable storage medium has encoded thereon instructions that, when executed on a computer, causes the computer to secure prosthetic teeth in the recesses of the fabricated base via the fabrication apparatus. In some embodiments, the computer readable storage medium has encoded thereon instructions that, when executed on a computer, causes the computer to scan the template via a cone beam computerized tomography (CBCT) scanner. In some embodiments, the computer readable storage medium has encoded thereon instructions that, when executed on a computer, causes the computer to use a CAD model of prosthetic teeth to design a location and shape of each of the plurality of recesses. In some embodiments, the computer readable storage medium has encoded thereon instructions that, when executed on a computer, causes the computer to add surface festoons to the CAD model that are representative of intra-oral anatomical features.

Other embodiments of the invention are directed to a computer program product for fabricating a dental prosthesis during a single office visit, comprising a non-transitory computer readable storage medium having encoded thereon instructions that, when executed on a computer, cause the computer to: scan intra-oral anatomy of a patient; display a computer aided design (CAD) model representing the scanned intra-oral anatomy; and manipulate the CAD model to design a base for the dental prosthesis having a plurality of recesses shaped to receive teeth.

In some embodiments, the computer readable storage medium has encoded thereon instructions that, when executed on a computer, causes the computer to fabricate the base from the manipulated CAD model via a fabrication apparatus. In some embodiments, the computer readable storage medium has encoded thereon instructions that, when executed on a computer, causes the computer to secure prosthetic teeth in the recesses of the fabricated base via the fabrication apparatus. In some embodiments, the computer readable storage medium has encoded thereon instructions that, when executed on a computer, causes the computer to scan the intra-oral anatomy of a patient via a cone beam computerized tomography (CBCT) scanner. In some embodiments, the computer readable storage medium has encoded thereon instructions that, when executed on a computer, causes the computer to use a CAD model of prosthetic teeth to design a location and shape of each of the plurality of recesses. In some embodiments, the computer readable storage medium has encoded thereon instructions that, when executed on a computer, causes the computer to add surface festoons to the CAD model that are representative of intra-oral anatomical features.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE DRAWINGS

FIG. 1 is a schematic illustration of a system for fabricating a dental prosthesis during a single office visit according to some embodiments.

FIG. 2A is an exploded view of a template that is representative of at least a portion of a patient's intra-oral anatomy according to some embodiments.

FIG. 2B is an assembled side perspective view of the template of FIG. 2A according to some embodiments.

FIG. 3 is a side view of the template of FIG. 2B mated with another template according to some embodiments.

FIG. 4 is a schematic illustration of a cone beam computerized tomography scanner configured to scan at least a portion of a patient's intra-oral anatomy according to some embodiments.

FIG. 5 is a schematic illustration of a computerized model of either the scanned template of FIG. 2B or the scanned intra-oral geometry of FIG. 4 according to some embodiments.

FIG. 6 is a schematic illustration of the computerized model of FIG. 5 with models of prosthetic teeth positioned relative thereto according to some embodiments.

FIG. 7 is a side perspective view of a fabricated base for a dental prosthesis according to some embodiments.

FIG. 8 is a partially exploded view of the base of FIG. 7 with prosthetic teeth positioned relative thereto according to some embodiments.

FIG. 9 is a top schematic view of a plurality of interconnected prosthetic teeth according to some embodiments.

FIG. 10A is a top view of the base and teeth of FIG. 8 according to some embodiments.

FIG. 10B is a bottom perspective view of the base of FIG. 10A according to some embodiments.

FIG. 11A is a side perspective view of a fabricated base with prosthetic teeth secured thereto according to some embodiments.

FIG. 11B is a top view of the base of FIG. 11A according to some embodiments.

FIG. 11C is a bottom perspective view of the base of FIG. 11A according to some embodiments.

FIGS. 12 and 13 are flow charts of operations that can be used to fabricate a dental prosthesis in a single office visit according to some embodiments.

FIG. 14 is a block diagram that illustrates details of an exemplary processor and memory that may be used to fabricate a dental prosthesis in a single office visit according to some embodiments.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

As used herein, the term “comprising” or “comprises” is open-ended, and includes one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items.

As used herein, the common abbreviation “e.g.,” which derives from the Latin phrase “exempli gratia,” may be used to introduce or specify a general example or examples of a previously mentioned item, and is not intended to be limiting of such item. If used herein, the common abbreviation “i.e.,” which derives from the Latin phrase “id est,” may be used to specify a particular item from a more general recitation.

The terminology used herein is for the purpose of describing particular embodiments only and is not intended to be limiting of the invention. As used herein, the singular forms “a,” “an” and “the” are intended to include the plural forms as well, unless the context clearly indicates otherwise.

Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

Exemplary embodiments of the present invention are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments of the present invention may be implemented in hardware and/or in software (including firmware, resident software, micro-code, etc.). Furthermore, exemplary embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Python, Java, AJAX (Asynchronous JavaScript), C, and/or C++, for development convenience, and may be associated with computer aided design software such as AutoCAD, PRO/Desktop and PRO/Engineer. In addition, computer program code for carrying out operations of exemplary embodiments of the present invention may also be written in other programming languages, such as, but not limited to, interpreted languages. Some modules or routines may be written in assembly language or even micro-code to enhance performance and/or memory usage. However, embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

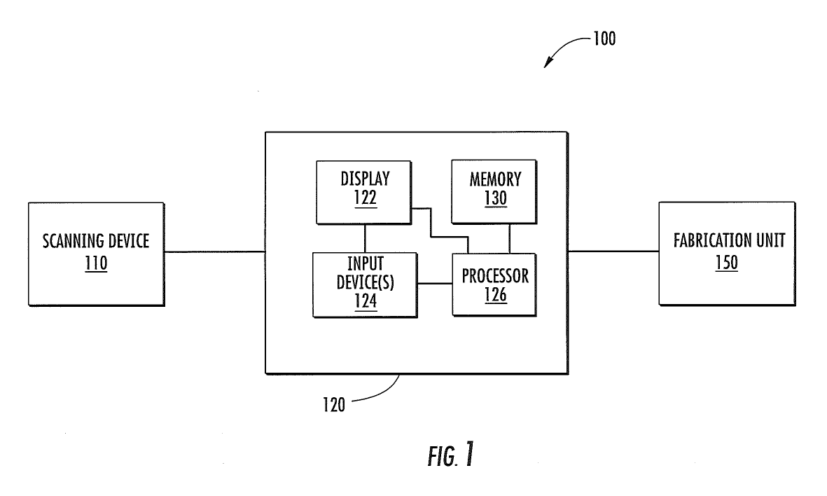

FIG. 1 illustrates an exemplary system 100 for fabricating a dental prosthesis during a single office visit. The system 100 includes a scanning device 110 configured to acquire three dimensional data of at least a portion of a patient's intra-oral anatomy. In some embodiments, the scanning device 110 is used to scan a template that is representative of at least a portion of a patient's intra-oral anatomy. In other embodiments, the scanning device 110 is used to directly scan at least a portion of a patient's intra-oral anatomy. The scanning device 110 may a computerized tomography (CT) scanner and, in some embodiments, may be a cone beam computerized tomography (CBCT) scanner.

The system 100 includes a design station 120 in communication with the scanning device 110. As illustrated, the design station includes a display 122, user input device(s) 124, a controller or processor 126 and a memory 128. The design station 120 is configured to display (e.g., on the display 122) a model of the patient's intra-oral anatomy based on the three dimensional data acquired by the scanning device 110. The design station 120 is configured to manipulate the model displayed within the display 122 via one or more graphical user interfaces (GUIs) (e.g., in response to input to the user input device(s) 124) to design a base for the dental prosthesis. The model may be a computerized three dimensional model such as a computer aided design (CAD) model. Various GUIs allow a user to easily and dynamically manipulate the model.

The system 100 includes a fabrication unit 150 in communication with the design station 120. The fabrication unit 150 is configured to fabricate the dental prosthesis base from the CAD model that has been manipulated at the design station 120. The fabrication unit 150 may comprise a milling unit and may be configured to mill the base from polymeric material such as acrylic.

The scanning device 110, the design station 120 and the fabrication unit 150 are typically all located within a practitioner's office. In this regard, the processes described herein are streamlined to allow for a dental prosthesis such as a denture to be fabricated from start to finish in a single office visit, often within one hour. The centralized location of the components also allows for practitioner and/or patient oversight of the entire process from start to finish. As a result, the practitioner may be able to quickly detect and correct errors during the process. Also, the patient and the practitioner are able to communicate more effectively during the process, for example regarding preferences for the end product.

The design station 120 may comprise a personal or tablet computer or the like. At least a portion of the design station 120, such as the display 122, may be located in a room in which the patient is situated or to which the patient may move. As such, the patient and the practitioner can view the display 122 together to more easily interact during the fabrication process. A separate display may be included in the patient's room for these purposes (for example, a duplicative display). Further, the display 122 or a separate display may be portable such that it may be carried from, for example, the patient's room to the fabrication unit 150. In this regard, a device such as a tablet computer, smartphone or the like may include the display 122 or the device may include a separate display and be in communication (e.g., wireless communication) with the design station 120.

Although the scanning device 110, the design station 120 and the fabrication unit 150 have been described as discrete components, it is contemplated that one or more of them may be combined. Further, although a controller or processor has only been illustrated with respect to the design station 120, it is contemplated that the scanning device 110 and/or the fabrication unit 150 include a dedicated controller and that one or more of the scanning device 110, the design station 120 and the fabrication unit 150 share a controller in various embodiments. The scanning device 110, the design station 120 and the fabrication unit 150 and any associated controllers may be in communication by a wired or by a wireless connection.

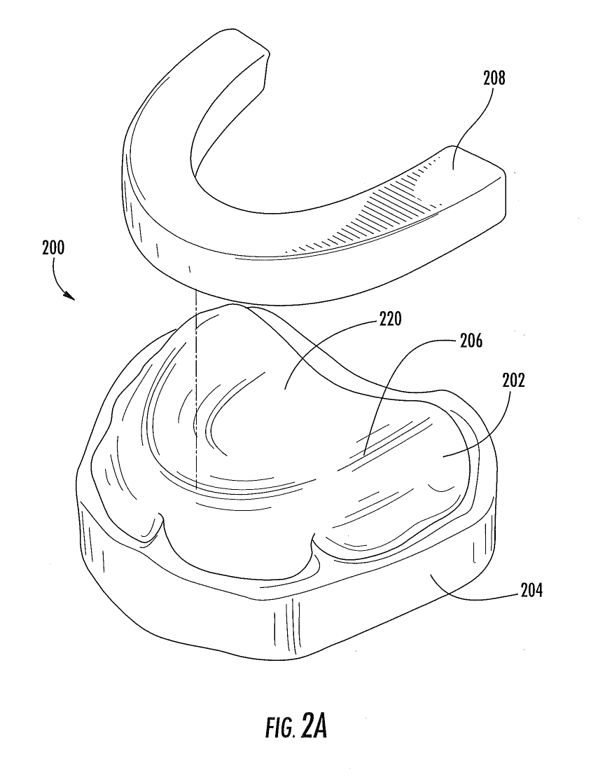

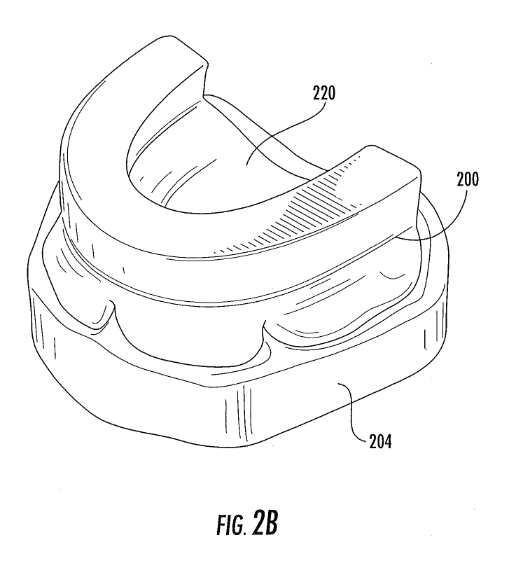

FIGS. 2A and 2B illustrate an exemplary template 200 that is representative of at least a portion of a patient's intra-oral anatomy. A baseplate 202, which may be wax, is adapted to or applied over a cast 204. The cast 204 may be formed from an impression taken of at least a portion of a patient's intra-oral anatomy. For example, the cast 204 may define the patient's edentulous ridge and/or ridge crest such that the baseplate 202 includes a relatively raised portion 206 when applied over the cast 204. As is understood by those of skill in the art, the cast 204 may be formed from a “primary” impression material such as alginate or may be formed from a “secondary” impression material such as TRIAD® custom tray material.

An occlusion rim 208, which may also be wax, may be attached to the baseplate 202. In particular, the occlusion rim 208 may be attached to the baseplate 202 at the raised portion 206. In some embodiments, a bead of sticky wax (not shown) is placed onto the raised portion 206 to help secure the occlusion rim 208 in position. The occlusion rim 208 may be heated (e.g., immersed in a heated water bath) to soften the material and allow it to be more easily manipulated or shaped. In some embodiments, the template 200 is a single-piece component (e.g., the baseplate 202 and occlusion rim 208 are integrated without need for attachment).

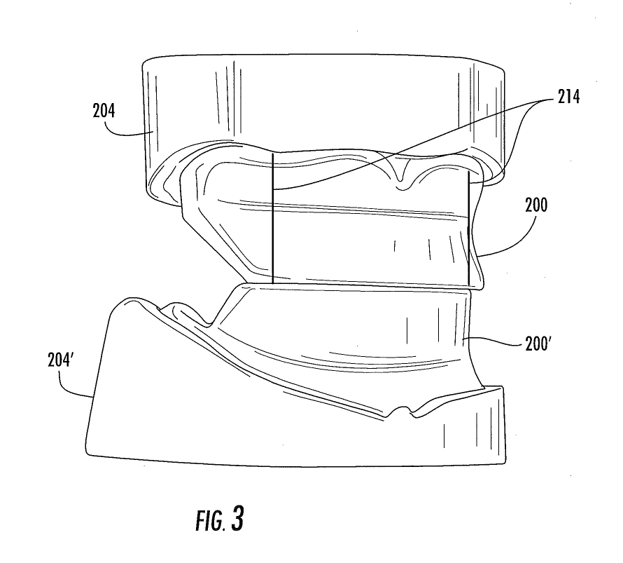

The template 200 shown in FIGS. 2A and 2B may be used for a base of an upper denture. A similar template 200′ (FIG. 3) may be formed and used for a lower denture. The templates 200, 200′ may have different features. For example, the baseplate 202 of the template 200 may be adapted to or applied over the cast 202 so as to define a palate portion 220. In contrast, the template 200′ for a lower denture may not include a palate portion.

FIG. 3 illustrates the templates 200, 200′ generally in position for occlusal registration. Although the templates 200, 200′ are shown positioned in their respective casts 204, 204′, the templates 200, 200′ are positioned in a patient's mouth for the actual occlusal registration. As is understood by those of skill in the art, various measurements are performed during occlusal registration. For example, the patient's vertical dimension, occlusal plane, centric relation and/or maxillo-mandibular relationship may be established and/or recorded. The templates 200, 200′ may be trimmed or otherwise modified based on these and other measurements, as would be understood by one skilled in the art.

The template 200 is scanned using the scanning device 110. In some embodiments, the template 200 comprises radio-opaque material, such as barium sulfate. The radio-opaque material may be located within the template 200 (e.g., blended in the template). The radio-opaque material may be located on one or more portions of a surface of the template 200. The radio-opaque material may be particularly useful when the scanning device 110 is a CBCT scanner as CBCT allows radio-opaque objects to be localized and accessed in three dimensions and the radio-opaque material allows for the delineation of sharp margins.

As shown in FIG. 3, at least one alignment member 214 may be applied to the template 200. The alignment member(s) 214 may comprise thin wire that is visible in an x-ray. The alignments member(s) 214 may be used to indicate various locations and measurements, such as the midline and canine position, when the template 200 is scanned. The alignment member(s) 214 may be used in lieu of or in addition to the radio-opaque material described above.

In some embodiments, the template 200 is scanned outside the mouth of the patient. In other embodiments, the template 200 is scanned while positioned in the mouth of the patient.

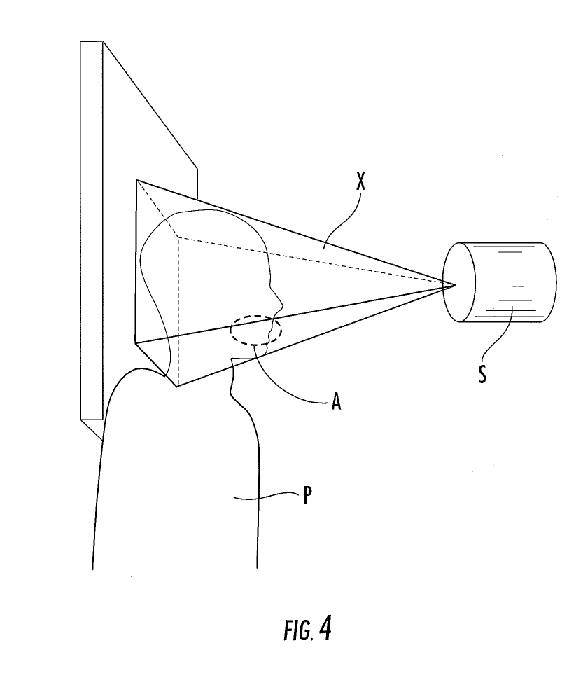

In some embodiments, and as shown in FIG. 4, rather than forming and scanning the template 200, intra-oral anatomy A of a patient P is scanned using the scanning device 110. In the illustrated embodiment, the scanning device is a CBCT scanner having a cone beam source S that produces a cone beam x-ray X to capture three dimensional data of the patient's intra-oral anatomy A. The patient's intra-oral anatomy A may include the bone and tissue structure that would otherwise be defined by one or more impressions as described above.

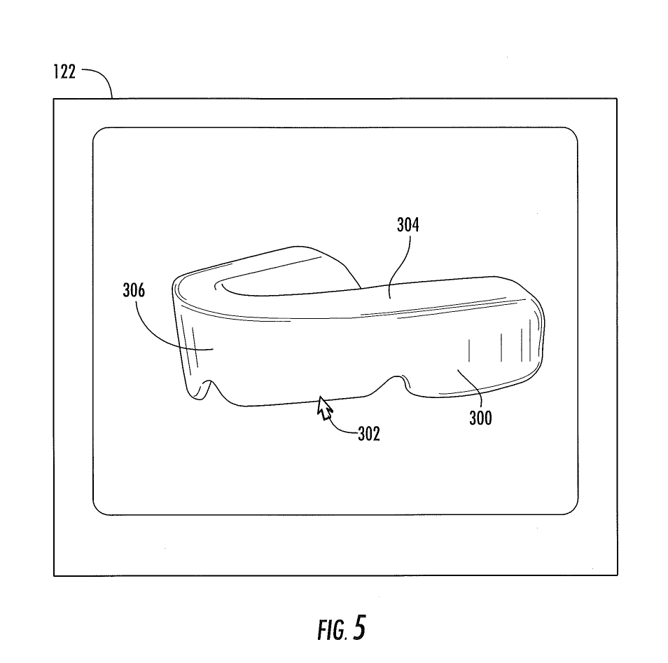

The scanning device 110 communicates data to the design station 120, where a computerized three dimensional model 300 such as a CAD model is displayed on the display 122, as shown in FIG. 5. It will be understood that the model 300 is representative of at least a portion of a patient's intra-oral anatomy and may be based on either the scanned template 200 (FIGS. 2A and 2B), the directly scanned intra-oral anatomy A (FIG. 4), or a combination of scanned template data and scanned intra-oral anatomy data.

The model 300 may be manipulated by the operator. For example, the model 300 may be rotated, flipped, zoomed, etc. in three dimensions. The user input device(s) 124 of the design station 120 may comprise a mouse, trackball, trackpad or other pointing device to allow the operator to control a cursor or pointer 302 on the display 122 to manipulate the model 300. The operator may manipulate the model 300 in a number of other manners, for example by input to a keyboard/keypad, input to a touch screen (e.g., the display 122 may be a touch display) or by voice commands. The operator may manipulate the model 300 in a number of directions or ways to inspect the model 300 and verify the model 300 is sufficiently representative of the template 200 (FIGS. 2A and 2B) and/or the patient's intra-oral anatomy A (FIG. 4) before proceeding further.

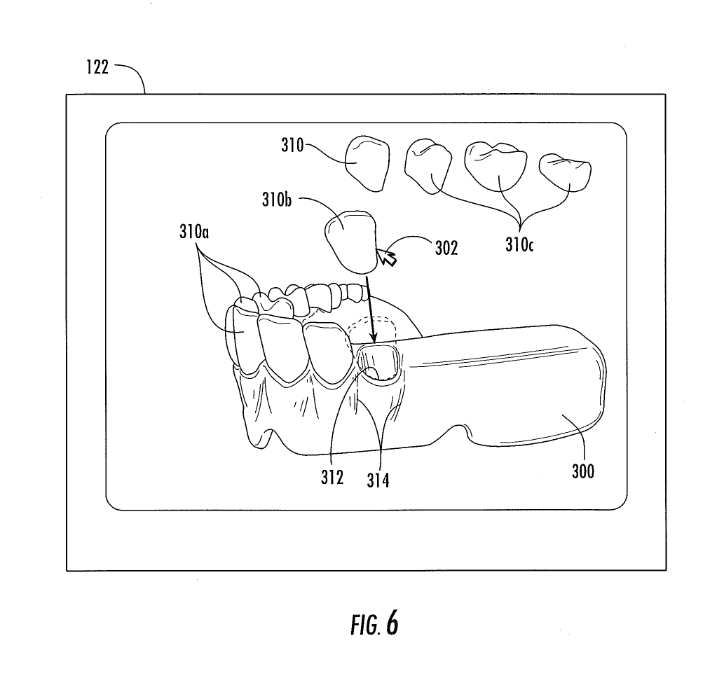

Turning to FIG. 6, the operator may select models 310 of prosthetic teeth for display and interaction with the model 300 on the display 122. The tooth models 310 may be representative of available prosthetic teeth that can be used later in the fabrication process. The tooth models 310 may be stored in the memory 128 of the design station 120, and may be identified by tooth type, tooth shape, tooth size, color/tint and other criteria. The operator may select the tooth models 310 from a “library” of available prosthetic teeth or may enter codes based on the desired criteria. It is contemplated that the operator may manipulate the available tooth models 310. That is, if the “library” doesn't contain a model of a prosthetic tooth that matches the specifications for a particular patient, the operator may select a tooth model 310 and manipulate it by, for example, changing its size or shape. The fabrication unit 150 may be configured to fabricate or mill a prosthetic tooth to correspond to the manipulated tooth model; alternatively, the prosthetic tooth may be fabricated using a different unit (e.g., a CEREC® machine or the like) or may be hand fabricated or milled.

In some embodiments, a patient's actual teeth are scanned prior to extraction. The teeth may be scanned using the scanning device 110, for example. Models of the patient's actual teeth may be stored in the memory 128 of the design station 120. The design station 120 and/or the operator may search for and identify prosthetic teeth having stored tooth models 310 that have substantially identical characteristics. If an appropriate stored model 310 cannot be located, a closely corresponding tooth model 310 may be manipulated in the manner described above or a prosthetic version of the actual tooth may be fabricated based on the model thereof.

Once a prosthetic tooth model 310 has been selected, it may be positioned relative to the model 300. For example, the tooth model 310 may be positioned on or through a top surface 304 and/or an outer side surface 306 of the model 300 (FIG. 6). In the embodiment illustrated in FIG. 6, the cursor 302 is used to “drag” the tooth model 310 to its desired location relative to the model 300 within the user interface displayed.

Thus, the model 300 may be manipulated by positioning the tooth models 310 relative to the model 300 or by superimposing the tooth models 310 on the model 300. In the embodiment shown in FIG. 6, several tooth models 310a have already been positioned relative to the model 300. A tooth model 310b is shown in the process of being positioned, with the arrow and the broken lines showing its ultimate placement or position relative to the model 300. As illustrated, the placement or positioning of the tooth model 310b involves manipulation of the model 300 such as forming a recess 312 in the model 300 and/or forming surface festoons 314 on the model 300. The recess 312 may be shaped to receive the prosthetic tooth that is represented by the tooth model 310b. The surface festoons 314 may be representative of intra-oral anatomical features. It will be understood that at least some of the surface festoons 314 and other intra-oral anatomical features may be formed or modified by the practitioner using the design station 120.

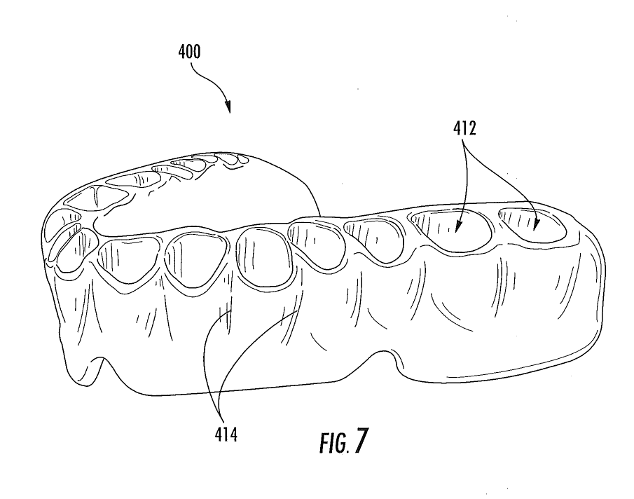

Turning to FIG. 7, a base 400 for the dental prosthesis is fabricated using the fabrication unit 150 based on the manipulated model 300. The base 400 includes a plurality of recesses 412 that are shaped to receive teeth. Each recess 412 in the base 400 may correspond to a respective recess 312 of the manipulated model 300. The base 400 may also include surface festoons 414 which correspond to the surface festoons 314 of the manipulated model 300. It will be understood that the model 300, when manipulated and viewed on the display 122, may not include recesses 312 and/or surface festoons 314. That is, the model 300 may be manipulated by selecting and positioning or superimposing the tooth models 310 relative thereto so as to design a location and shape of each of the plurality of recesses 412 of the base 400. Similarly, the model 300 may be manipulated by selecting and positioning the tooth models 310 relative thereto so as to design a location and shape of the surface festoons 414 of the base 400. In other words, the recesses 412 and/or the surface festoons 414 of the base 400 may be formed automatically without necessarily displaying corresponding features on the manipulated model 300.

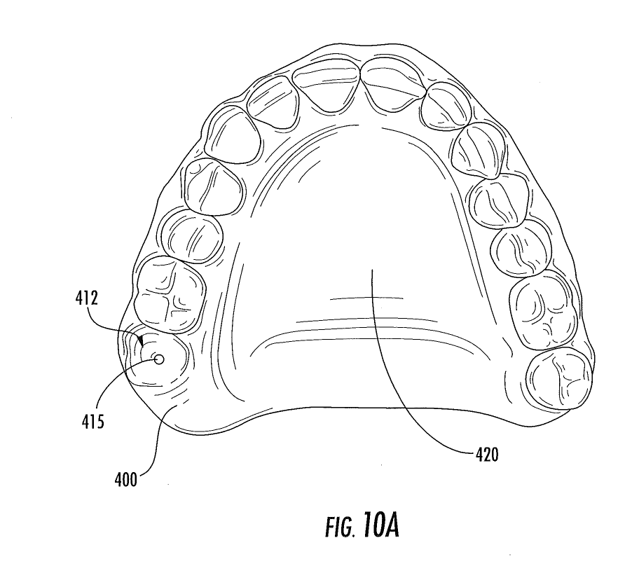

As illustrated in FIG. 8, prosthetic teeth 410 are secured in the recesses 412 of the fabricated base 400. Each prosthetic tooth 410 may correspond to its respective model 310 that was used to manipulate the model 300. In some embodiments, the teeth 410 are adhesively secured in the recesses 412. In some embodiments, one or more of the teeth 410 may include one or more downwardly extending projections 414 configured to be received in a respective one or more cavities 415 (FIG. 10A) formed in a respective recess 412. The one or more projections 414 may be used in conjunction with an adhesive and may provide additional stability and/or security for the tooth 410 in the recess 412. In the illustrated embodiment of FIG. 8, only a single projection 414 is illustrated.

The fabrication unit 150 may comprise a milling unit that is configured to mill the dental prosthesis base 400 from a polymeric material such as acrylic. In some embodiments, the fabrication unit 150 is configured to secure the prosthetic teeth 410, which may also comprise polymeric material such as acrylic, in the recesses 412 of the fabricated base 400. In some embodiments, the fabrication unit 150 is configured to fabricate the base 400 and teeth 410 as a one-piece polymeric component. The fabrication unit 150 may be configured to paint or coat the base 400 and/or the teeth 410 such that the base 400 and the teeth 410 are different colors. As described above, in some embodiments, the fabrication unit 150 is configured to fabricate or mill one or more of the prosthetic teeth 410 to be secured to the base.

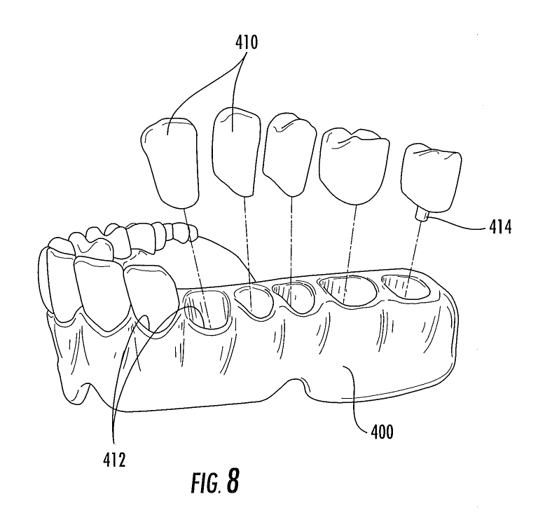

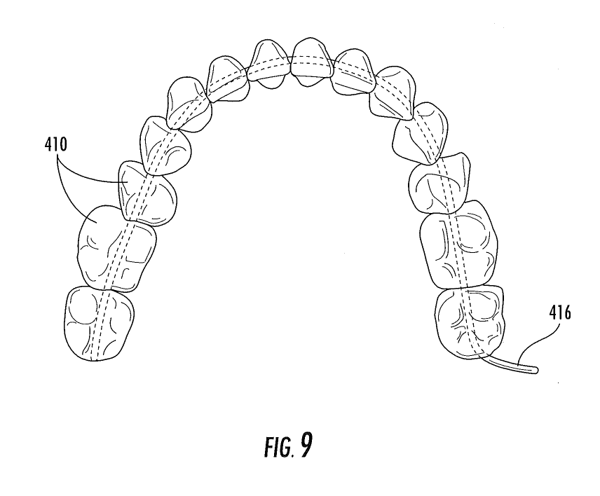

In some embodiments, and as illustrated in FIG. 9, one or more of the teeth 410 are interconnected to facilitate placement in the recesses 412. The teeth 410 may be interconnected by a flexible member 416 such as a cord, string or wire. The flexible member 416 may be removable (e.g., after the teeth 410 have been secured in the recesses 412).

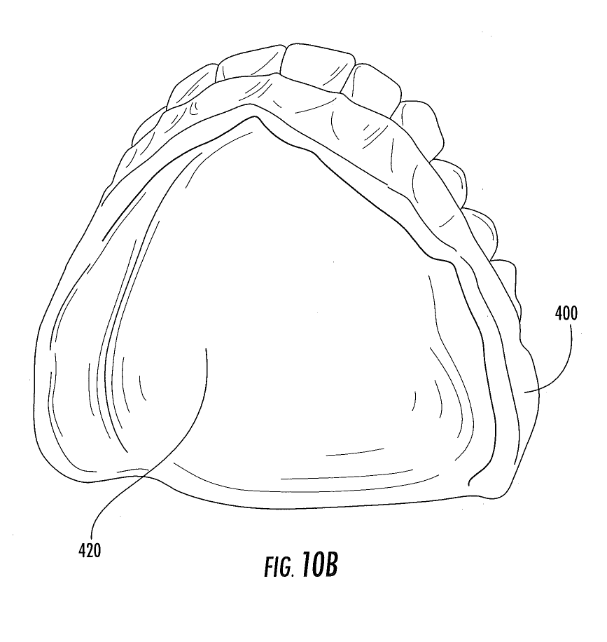

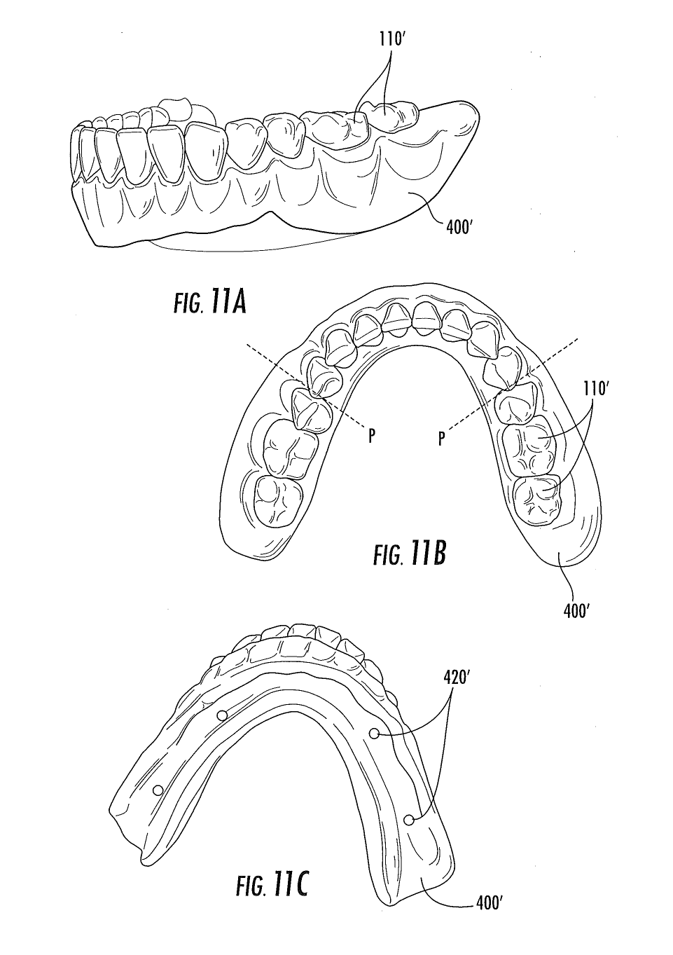

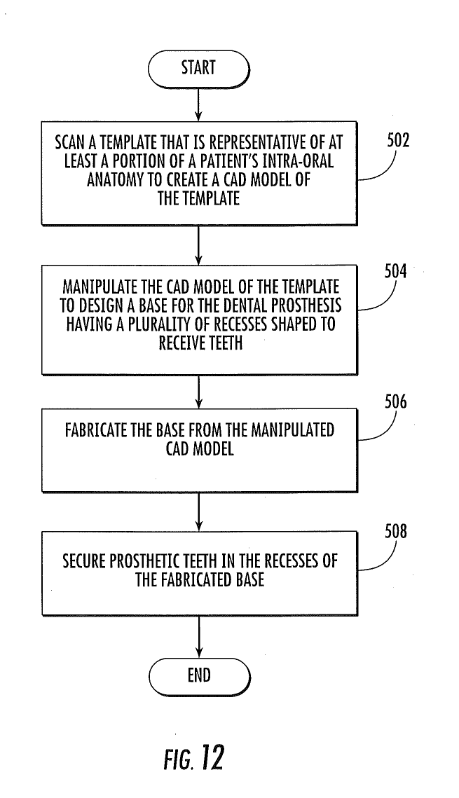

FIGS. 10A and 10B show additional views of the fabricated base 400. As described above, the base 400 may be fabricated for use as an upper denture. A different base 400′, illustrated in FIGS. 11A-C, may be fabricated for use as a lower denture. The base 400′ may be fabricated in the same or substantially same way as the base 400. That is, the base 400′ may be fabricated based on a model similar to the model 300 described above, and the model may be based on data acquired from scanning the template 200′ (FIG. 3), from directly scanning the patient's intra-oral anatomy A (FIG. 4), or a combination thereof. The base 400′ may have different features than the base 400. For example, the base 400 may include a palate portion 420, whereas the base 400′ may not include such a portion.

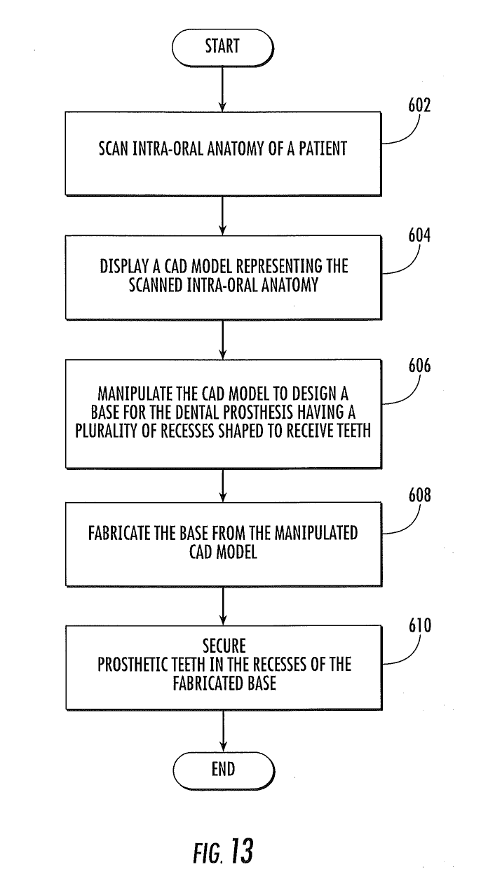

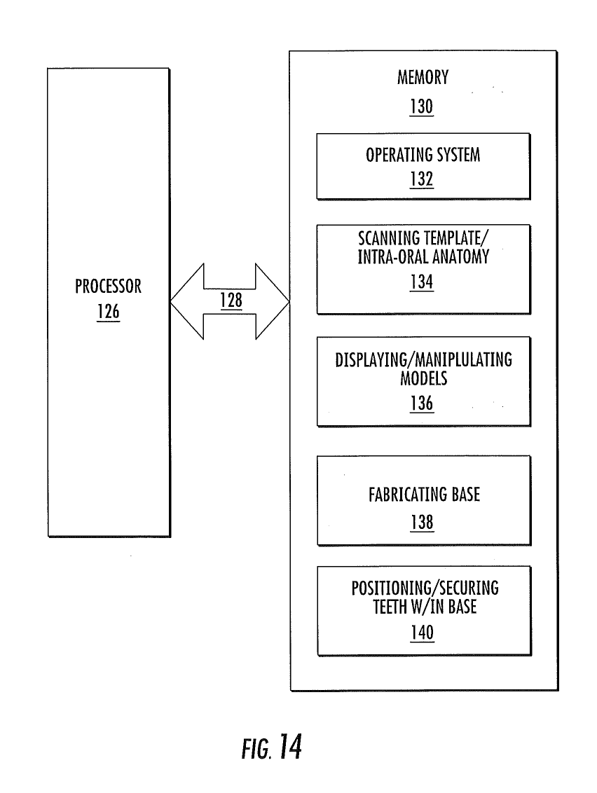

FIGS. 12 and 13 illustrate exemplary operations that can be used to fabricate a dental prosthesis during a single office visit. Referring first to FIG. 12, a template that is representative of at least a portion of a patient's intra-oral anatomy is scanned to create a CAD model of the template (Block 502). The CAD model of the template is manipulated to design a base for the dental prosthesis having a plurality of recesses shaped to receive teeth (Block 504). The base is fabricated from the manipulated CAD model (Block 506). Prosthetic teeth are secured in the recesses of the fabricated base (Block 508).

Turning to FIG. 13, intra-oral anatomy of a patient is scanned (Block 602). A CAD model representing the scanned intra-oral anatomy is displayed (Block 604). The CAD model is manipulated to design a base for the dental prosthesis having a plurality of recesses shaped to receive teeth (Block 606). The base is fabricated from the manipulated CAD model (Block 608). Prosthetic teeth are secured in the recesses of the fabricated base (Block 610).

It will be understood that certain steps of the above-described operations may be omitted, may be performed together, or may be performed in a different order than as presented. It will also be understood that additional steps may be performed based on the description herein.

The systems and methods described herein can provide several advantages. First, many of the steps performed in the conventional denture producing process are eliminated and replaced with a more error-free streamlined process. In particular, the step of setting the teeth in a wax base, which is perhaps the most time-consuming and error-prone step of the conventional process, is eliminated. Instead, the model of the patient's intra-oral anatomy is electronically manipulated by, for example, placing three dimensional models of the teeth relative to the three dimensional intra-oral anatomy model. In this regard, the practitioner has complete control of the selection and placement of the teeth rather than relying on a back-and-forth approach with a laboratory technician. The practitioner can view the model on a display as the model is being manipulated and make necessary adjustments and corrections prior to fabrication of the base.

Also, the entire system is contained and the entire process is performed at the practitioner's office. This eliminates the back-and-forth shipments with the laboratory, which may cause damage, delay and general uncertainty. It also provides the practitioner and/or the patient the ability to have complete oversight of the process. As mentioned above, this allows the practitioner to identify and correct errors or issues quickly. It also allows for increased interaction between the practitioner and the patient. For example, the practitioner may share with the patient the manipulated model on a display, with the manipulated model substantially corresponding to the appearance of the potential finished product. The manipulated model may even be placed or positioned relative to or combined with an image of the patient's face to give the patient and practitioner a sense of how the finished product would look in use. The patient and practitioner can share ideas and express concerns regarding aspects such as tooth color, size, placement, etc. as well as surface festoons or other anatomical features. The practitioner can then further manipulate the model based on any desired preferences. Thus, the present invention allows for problems to be addressed and preferences to be incorporated proactively before fabrication of the end product and leads to fabrication of an end product that more closely meets the patient's and the practitioner's expectations.

Furthermore, adjustments to the fabricated product can be made with minimal delay. For example, if the patient or the practitioner identifies one or more problems with the fit of the fabricated base, the practitioner can further manipulate the model to address the problems. The base can be returned to the fabrication unit and adjusted based on the further manipulated model.

The fabrication unit may also provide much greater precision over conventional methods of “finishing” the denture. The fabrication unit may be a high-speed milling unit using diamond or diamond coated instruments to mill a ceramic block to a precision of about +/−25 microns or less and may be able to mill the denture base in about five to about ten minutes or less. Accurate and rapid rework of the base, if needed, can also be performed with such a unit.

The methods and systems described herein allow for a dental prosthesis to be fabricated in a single office visit. In various embodiments, a high-quality denture may be fabricated in less than about four hours, less than about two hours and less than about one hour from the time the patient arrives at the office.

Although the above discussion has focused on full dentures, the systems and method described herein can be employed to fabricate other dental prostheses in a single office visit. For example, partial dentures can be fabricated, such as a partial denture indicated by the lines P in FIG. 11B.

The denture bases may also be fabricated to accommodate dental implants. As illustrated in FIG. 11C, the base 400′ includes a plurality of apertures 420′, with each aperture 420′ sized and configured to receive a respective implant, which may secure and stabilize the denture in place. Moreover, the model 300 (FIG. 5) that is based on a scan of a template representing at least portion of a patient's intra-oral anatomy and/or a direct scan of a patient's intra-oral anatomy using a CBCT scanner may be used for precise placement of the implants and/or the apertures 420′. In particular, a CBCT scan is capable of determining locations in the edentulous ridge that have sufficient height and width to safely receive and hold an implant. The practitioner can then place implants at one or more of these locations, and the model can be manipulated to fabricate the base 400′ with the apertures 420′ precisely positioned to receive the implants.

FIG. 14 illustrates an exemplary processor 126 and memory 130 that may be used to fabricate a dental prosthesis according to some embodiments of the present invention. The processor 126 communicates with the memory 130 via an address/data bus 128. The processor 126 may be, for example, a commercially available or custom microprocessor. The memory 130 is representative of the overall hierarchy of memory devices containing the software and data used to implement a device or system for fabricating a dental prosthesis as described herein, in accordance with some embodiments of the present invention. The memory 130 may include, but is not limited to, the following types of devices: cache, ROM, PROM, EPROM, EEPROM, flash, SRAM, and DRAM.

As shown in FIG. 14, the memory 130 may hold various categories of software and data: an operating system 132, a scanning template/intra-oral anatomy module 134, a displaying/manipulating models module 136, a fabricating base module 138, and/or a positioning/securing teeth within base module 140. The operating system 132 controls operations of one or more devices used to host the modules 134, 136, 138, 140 and may manage the resources of one or more devices and/or coordinate execution of various programs (e.g., the modules 134, 136, 138, 140) by the processor 126.

The scanning template/intra-oral anatomy module 134 comprises logic for scanning a template that is representative of at least a portion of a patient's intra-oral anatomy to create a model of the template and/or for scanning intra-oral anatomy of a patient. The displaying/manipulating models module 136 comprises logic for displaying a computer model representing the scanned intra-oral anatomy, template, or combination thereof and/or for manipulating the model to design a base for the dental prosthesis having a plurality of recesses shaped to receive teeth. The fabricating base module 138 comprises logic for fabricating the base from the manipulated model. The positioning/securing teeth within base module 140 comprises logic for positioning and/or securing prosthetic teeth in the recesses of the fabricated base.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. A method for fabricating a dental prosthesis during a single office visit, the method comprising:
scanning a template that is representative of at least a portion of a patient's intra-oral anatomy to create a computer aided design (CAD) model of the template;
manipulating the CAD model of the template to design a base for the dental prosthesis having a plurality of recesses shaped to receive teeth;
fabricating the base from the manipulated CAD model; and
securing prosthetic teeth in the recesses of the fabricated base.

2. A method according to claim 1, wherein the template comprises radio-opaque material and wherein scanning the template is performed using a cone beam computerized tomography (CBCT) scanner.

3. A method according to claim 2, wherein the radio-opaque material is located on one or more portions of a surface of the template.

4. A method according to claim 1, wherein the template comprises a baseplate formed on a cast of an impression of at least a portion of the patient's intra-oral anatomy and an occlusion rim attached to the baseplate.

5. A method according to claim 1, wherein the template is formed by:
taking an impression of at least a portion of the patient's intra-oral anatomy;
forming a cast of the impression;
applying a wax baseplate over the cast;
attaching a wax occlusion rim to the wax baseplate; and
performing occlusal registration with the baseplate and occlusion rim in the patient's mouth.

6. A method according to claim 1, wherein the template comprises at least one alignment member.

7. A method according to claim 1, wherein the dental prosthesis is a denture.

8. A method according to claim 1, wherein scanning the template comprises scanning the template in the patient's mouth.

9. A method according to claim 1, wherein manipulating the CAD model of the template includes using a CAD model of prosthetic teeth to design a location and shape of each of the plurality of recesses.

10. A method according to claim 1, wherein manipulating the CAD model of the template comprises adding surface festoons to the CAD model that are representative of intra-oral anatomical features.

11. A method according to claim 1, wherein securing prosthetic teeth in the recesses comprises adhesively securing the prosthetic teeth in the recesses.

12. A method according to claim 1, wherein the prosthetic teeth are interconnected to facilitate placement within the recesses.

13. A method according to claim 12, wherein the prosthetic teeth are interconnected by a flexible member.

14. A method according to claim 1, wherein each of the prosthetic teeth includes a downwardly extending projection configured to be received in a cavity formed in a respective recess of the fabricated base.

15. A method according to claim 1, wherein fabricating the base comprises milling the dental prosthesis base from polymeric material.

16. A method according to claim 1, wherein the prosthetic teeth comprise polymeric material.

17. A method for fabricating a dental prosthesis during a single office visit, the method comprising:
scanning intra-oral anatomy of a patient;
displaying a computer aided design (CAD) model representing the scanned intra-oral anatomy;
manipulating the CAD model to design a base for the dental prosthesis having a plurality of recesses shaped to receive teeth;
fabricating the base from the manipulated CAD model; and
securing prosthetic teeth in the recesses of the fabricated base.

18. A method according to claim 17, wherein scanning the intra-oral anatomy is performed using a cone beam computerized tomography (CBCT) scanner.

19. A method according to claim 17, wherein the dental prosthesis is a denture.

20. A method according to claim 17, wherein manipulating the CAD model includes using a CAD model of prosthetic teeth to design a location and shape of each of the plurality of recesses.

21. A method according to claim 17, wherein manipulating the CAD model comprises adding surface festoons to the CAD model that are representative of intra-oral anatomical features.

22. A method according to claim 17, wherein positioning prosthetic teeth in the recesses comprises adhesively securing the prosthetic teeth in the recesses.

23. A method according to claim 17, wherein fabricating the base comprises milling the dental prosthesis base from polymeric material.

24. A method according to claim 17, wherein the prosthetic teeth comprise polymeric material.

25. A system for fabricating a dental prosthesis during a single office visit, the system comprising:
a scanning device configured to acquire three dimensional data of a patient's intra-oral anatomy;
a design station in communication with the scanning device, wherein the design station is configured to display a computer aided design (CAD) model of the patient's intra-oral anatomy based on three dimensional data acquired by the scanning device, and wherein the design station is configured to manipulate the CAD model to design a base for the dental prosthesis having a plurality of recesses shaped to receive teeth; and
a fabrication unit in communication with the design station, wherein the fabrication unit is configured to fabricate the dental prosthesis base from the manipulated CAD model.

26. A system according to claim 25, wherein the scanning device is a cone beam computerized tomography (CBCT) scanner.

27. A system according to claim 25, wherein the fabrication unit is further configured to secure a plurality of prosthetic teeth in the recesses of the fabricated dental prosthesis base.

28. A system according to claim 25, wherein the fabrication unit is further configured to add surface festoons to the dental prosthesis base that are representative of intra-oral anatomical features.

29. A system according to claim 25, wherein the fabrication unit comprises a milling unit configured to mill the dental prosthesis base from polymeric material.

30. A computer program product for fabricating a dental prosthesis during a single office visit, comprising a non-transitory computer readable storage medium having encoded thereon instructions that, when executed on a computer, cause the computer to:
scan a template that is representative of at least a portion of a patient's intra-oral anatomy to create a computer aided design (CAD) model of the template; and
manipulate the CAD model of the template to design a base for the dental prosthesis having a plurality of recesses shaped to receive teeth.

31. The computer program product of claim 30, wherein the computer readable storage medium has encoded thereon instructions that, when executed on a computer, causes the computer to fabricate the base from the manipulated CAD model via a fabrication apparatus.

32. The computer program product of claim 30, wherein the computer readable storage medium has encoded thereon instructions that, when executed on a computer, causes the computer to secure prosthetic teeth in the recesses of the fabricated base via the fabrication apparatus.

33. The computer program product of claim 30, wherein the computer readable storage medium has encoded thereon instructions that, when executed on a computer, causes the computer to scan the template via a cone beam computerized tomography (CBCT) scanner.

34. The computer program product of claim 30, wherein the computer readable storage medium has encoded thereon instructions that, when executed on a computer, causes the computer to use a CAD model of prosthetic teeth to design a location and shape of each of the plurality of recesses.

35. The computer program product of claim 30, wherein the computer readable storage medium has encoded thereon instructions that, when executed on a computer, causes the computer to add surface festoons to the CAD model that are representative of intra-oral anatomical features.

36. A computer program product for fabricating a dental prosthesis during a single office visit, comprising a non-transitory computer readable storage medium having encoded thereon instructions that, when executed on a computer, cause the computer to:
scan intra-oral anatomy of a patient;
display a computer aided design (CAD) model representing the scanned intra-oral anatomy; and
manipulate the CAD model to design a base for the dental prosthesis having a plurality of recesses shaped to receive teeth.

37. The computer program product of claim 36, wherein the computer readable storage medium has encoded thereon instructions that, when executed on a computer, causes the computer to fabricate the base from the manipulated CAD model via a fabrication apparatus.

38. The computer program product of claim 36, wherein the computer readable storage medium has encoded thereon instructions that, when executed on a computer, causes the computer to secure prosthetic teeth in the recesses of the fabricated base via the fabrication apparatus.

39. The computer program product of claim 36, wherein the computer readable storage medium has encoded thereon instructions that, when executed on a computer, causes the computer to scan the intra-oral anatomy of a patient via a cone beam computerized tomography (CBCT) scanner.

40. The computer program product of claim 36, wherein the computer readable storage medium has encoded thereon instructions that, when executed on a computer, causes the computer to use a CAD model of prosthetic teeth to design a location and shape of each of the plurality of recesses.

41. The computer program product of claim 36, wherein the computer readable storage medium has encoded thereon instructions that, when executed on a computer, causes the computer to add surface festoons to the CAD model that are representative of intra-oral anatomical features.
